(19) United States
(12) Patent Application Publication
(10) Pub. No.: US 2007/0168183 A1
(43) Pub. Date: Jul. 19, 2007

(54) Audio distribution system, an audio encoder, an audio decoder and methods of operation therefore

(75) Inventor: Leon Maria Van De Kerkhof, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,971

(22) PCT Filed: Feb. 11, 2005
(86) PCT No.: PCT/IB05/50533

§ 371 Date: Aug. 15, 2006

(30) Foreign Application Priority Data
Feb. 17, 2004 (EP) 04100631.3

(51) Int. Cl. G10L 19/00

(52) U.S. Cl. 704/200.1

(57) ABSTRACT

A stereo audio encoder (100) comprises a parametric stereo encoder (115) which generates a mono signal and parametric stereo parameters for at least a high frequency part of an input stereo signal. A stereo intensity encoder (117) generates stereo intensity data for the mono signal. The mono signal and intensity data are encoded in accordance with an encoding standard such as MPEG Layer II and the parametric stereo parameters are included in the ancillary data sections by an output processor (113). Thus, a legacy decoder (such as an MPEG Layer II decoder) may generate a stereo signal using the stereo intensity data whereas a higher complexity decoder may generate a high quality audio signal using the parametric stereo parameters. A stereo decoder (200) receives the encoded data from the encoder (100). An intensity decoder (203) generates a stereo signal using intensity data. This is fed to a parametric stereo decoder (207) which processes the stereo signal in accordance with extracted parametric stereo data.

### FIELD OF THE INVENTION

The invention relates to an audio distribution system, an audio encoder, an audio decoder and methods of operation therefor and in particular to multi channel audio encoding and decoding.

### BACKGROUND OF THE INVENTION

In recent years, the distribution and storage of content signals in digital form has increased substantially. Accordingly, a large number of encoding standards and protocols have been developed.

One of the most widespread coding standards for digital audio encoding of audio signals is the Motion Picture Expert Group Layer 3 standard generally referred to as MP3. As an example, MP3 allows, a 30 or 40 megabyte digital PCM (Pulse Code Modulation) audio recording of a song to be compressed into e.g. a 3 or 4 megabyte MP3 file. The exact compression rate depends on the desired quality of the MP3 encoded audio. Other examples of audio encoding standards and techniques include MPEG AAC (Advanced Audio Coding), ATRAC3 (Adaptive TRansform Acoustic Coding), AC-3, PAC (Perceptual Audio Coder), DTS (Digital Theatre Systems) and Ogg Vorbis.

Audio encoding and compression techniques such as MP3 or AAC provide for very efficient audio encoding which allows audio files of relatively low data size and high quality to be conveniently distributed through data networks including for example the Internet.

Many encoding protocols also provide for efficient encoding of stereo (two-channel) signals. Specifically, intensity stereo coding and Mid/Side (MS) coding are well known in the field and are widely used techniques which exploit redundancy and irrelevancy between channels in stereo or multi channel audio coders. Using these techniques, it is possible to obtain a lower bit rate for a given sound quality, or to improve the sound quality at a given bit rate. Examples of audio coders employing these techniques are MPEG Layer II, MPEG Layer III (MP3), AAC, ATRAC3 and AC-3.

Intensity stereo coding allows a great reduction in bit rate compared to independent coding of audio channels. In intensity stereo, a mono audio signal is generated for the higher frequency range of the signal. In addition, separate intensity parameters are generated for the different channels. Typically, the intensity parameters are in the form of left and right scale factors which are used in the decoder to generate the left and right output signals from the mono audio signal. A variation is the use of a single scale factor and a directional parameter.

The intensity stereo coding technique has however several disadvantages. First of all, the encoder discards time- and phase information for the higher frequencies. The decoder therefore cannot reproduce the time- or phase channel differences that are present in the original audio material. Furthermore, in general, the encoding cannot preserve the correlation between the audio channels. Accordingly, a quality degradation of the stereo signal generated by the encoder cannot be avoided.

Furthermore, in subband coding, aliasing cancellation between neighbouring frequency bands of the encoding process relies on the exact total transfer function through the encoder and decoder for the individual subbands. As the transfer functions may be varied differently in different subbands due to the intensity data, the aliasing cancellation between neighbouring frequency bands is destroyed. A similar problem occurs in coders using an MDCT transform, relying on time-domain aliasing cancellation.

Additionally, when scale factors are used as intensity parameters, the accuracy of these parameters is in general not sufficient to obtain high audio quality.

Although MS coding does not suffer from these disadvantages the bit rate efficiency of MS coding is generally significantly lower, resulting in high data rates. In a worst-case situation, MS coding does not provide any gain in bit rate compared to independent coding of left and right channels.

Consequently, significant research has been undertaken to provide more efficient multi-channel encoding techniques. However, due to the widespread dissemination of existing encoding techniques, it is preferable for new techniques to be backwards compatible with existing protocols.

One technology which recently has been developed for encoding of multi-channel audio signals is known as Parametric Stereo (PS). This technology may be applied on top of other audio coding schemes in a backwards compatible fashion. Specifically, PS may generate stereo enhancement data to be added to mono MP3 or AAC encoded signals. The enhancement data may be stored in ancillary data sections of the MP3 or AAC data stream thereby allowing conventional decoders to ignore the additional data.

In PS, stereo audio encoding is achieved by encoding only a single mono signal using e.g. MP3 or AAC. In addition stereo imaging parameters are determined in the encoder and included in the data stream as separate extension data. At the decoder, the mono encoded channel is expanded into stereo channels by processing the mono encoded signal differently in the two channels dependent on the stereo imaging parameters. These parameters may consist of Inter-channel Intensity Differences (IID), Inter-channel Time or Phase differences (ITD or IPD) and Inter-channel Cross-Correlations (ICC).

For PS the enhancement parameters can be efficiently encoded into the ancillary data portion of the core coding scheme as long as the data rate of the enhancement parameters does not exceed the available capacity of the ancillary data sections. Alternatively, the amount of bits reserved for ancillary data can be selected such that the required PS enhancement data fits into it. Experiments indicate that high quality stereo encoding is possible with only a few kbps extra compared to a mono encoded signal.

Legacy decoders will not process the ancillary data but will only decode the core encoded data and in this way backwards compatibility is maintained as audio signals may be generated by legacy decoders.

However, a disadvantage of this technique is that legacy decoders will only reproduce the mono signal. Thus the stereo information comprised in the ancillary data sections is ignored. The mono representation of a stereo signal represents a serious quality degradation which is usually unacceptable.

Hence, an improved multi-channel audio coding/decoding technique would be advantageous and in particular a multi-channel audio coding/decoding technique providing improved performance, increased quality, reduced data rate and/or improved backwards compatibility would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided a multi channel audio encoder comprising: means for receiving an input multi channel signal; a parametric multi channel encoder for generating a single channel signal and multi channel parameters for at least a first part of the input multi channel signal; the multi channel parameters comprising multi channel information related to the single channel signal; a multi channel intensity encoder for generating multi channel intensity data in response to the input multi channel signal and the single channel signal; and means for generating encoded audio output data comprising the single channel signal, the intensity data and the multi channel parameters.

The multi channel intensity data may be compatible with a first coding standard, such as MP3, AAC etc. The single channel signal may be encoded according to the same encoding standard. In this application, the term multi-channel refers to two or more channels. The multi channel parameters may be parametric extension data and may specifically be parametric stereo data which may be used to provide a stereo signal from the single channel signal and possibly from the intensity data. In this application, the term stereo-channel refers to two channels and thus a stereo signal refers to a two-channel signal. The multi channel parameters may be in a format which is not comprised in the encoding standard used for the single channel signal or for the multi channel intensity data.

The encoder may provide a signal which can provide efficient and/or high quality multi channel encoding using the multi channel parameters. A suitable decoder may generate a high quality multi channel signal while a decoder not capable of exploiting the information of the multi channel parameters, for example a legacy decoder, may still provide a multi channel signal (although typically at a lower quality). Hence, the invention may allow improved performance and backwards compatibility and may specifically allow multi channel signal generation in legacy decoders.

Specifically, the multi channel parameters may be included in an ancillary (or auxiliary) data section of the encoded audio output data. For example, the multi channel parameters may be included in the ancillary data sections of an MP3 or AAC data stream. This will allow the multi channel parameters to be included in the encoded output data without affecting legacy encoders as these may simply ignore the ancillary data sections. However, suitable enhanced encoders may extract the multi channel parameters and use these in deriving high quality multi channel signals. Alternatively or additionally, the multi channel parameters may be transmitted separately form the encoded audio output data to the decoder, e.g. in a system level data stream.

The encoded audio output data may be a data stream or may for example be transmitted separately to the same decoder. The input multi channel signal may be received from an external source and/or an internal source such as from local memory.

The multi channel parameters preferably comprise Inter-channel Intensity Difference (IID) parameters; Inter-channel Time Difference (ITD) parameters; and/or Inter-channel Cross-Correlations (ICC) parameters.

The inter-channel parameters may also be referred to as inter-aural parameters and the ICC parameters may specifically be referred to as inter-aural correlation parameters.

These parameters are particularly advantageous and allow backwards compatible transmission of Parametric Stereo encoded multi-channel signals.

According to a feature of the invention, the Inter-channel Intensity Difference (IID) parameters are difference parameters relative to the intensity data. This may allow a more efficient encoding of the IID parameters resulting in reduced data rates and/or may provide for a reduced complexity encoding or decoding process.

According to another feature of the invention, the intensity data comprises individual scale factors for multiple channels. The scale factors may be represented in any suitable format, for example in polar format. This provides a suitable means of providing intensity information which may practically be used both for intensity decoding as for parametric decoding.

According to another feature of the invention, the multi channel parameters comprise scale factor difference values relative to the individual scale factors of the intensity data. The difference values may for example be polar component difference values. This provides for an easy to implement encoding and/or decoding process and provides data rate effective communication of both multi channel parameters and multi channel intensity data.

According to another feature of the invention, the multi channel audio encoder further comprises: means for dividing the input multi channel signal into the first part and a second part; and means for encoding the second part as a plurality of individually encoded single channel signals; and the means for generating is operable to include the individually encoded single channel signals in the encoded audio output data. Preferably, the second part corresponds to a low frequency band of the input signal and the first part corresponds to a high frequency band of the input signal.

This provides for high perceived quality yet efficient encoding of multi channel audio signals suitable for both intensity decoding and parametric decoding.

Preferably, the multi channel audio encoder is a stereo audio encoder. Specifically, the multi channel parameters preferably comprise parameters derived by Parametric Stereo encoding of an input stereo signal.

According to another feature of the invention, the multi channel audio encoder further comprises means for transmitting the encoded audio output data as a single data stream. Hence, the encoder may generate a single data stream which has a high encoding quality to data rate ratio and which is decodable as a multi channel in different types of decoders. Thus, the encoder may cause a distribution of the data stream to both enhanced and legacy decoders allowing both types to generate multi channels.

According to a second aspect of the invention, there is provided a method of encoding an audio signal comprising the steps of: receiving an input multi channel signal; generating a single channel signal and multi channel parameters for at least a first part of the input multi channel signal by parametric multi channel encoding; the multi channel parameters comprising multi channel information related to the single channel signal; generating multi channel intensity data in response to the input multi channel signal and the single channel signal; and generating encoded audio output data comprising the single channel signal, the intensity data and the multi channel parameters.

According to a third aspect of the invention, there is provided a multi channel audio decoder comprising: means for receiving a single channel signal, parametrically encoded multi channel parameters comprising multi channel information related to the single channel signal and intensity encoded multi channel intensity data related to the single channel signal; an intensity decoder for generating a first decoded signal from the single channel signal and the intensity data; and a parametric multi channel decoder operable to generate a decoded multi channel output signal from the first decoded signal and the parametrically encoded multi channel parameters.

The invention may thus provide a low complexity decoder suitable for decoding of audio encoding data comprising both parametrically encoded multi channel parameters and multi channel intensity data.

It will be appreciated that the features, comments and variants described above with reference to the encoder may also be applied to the decoder as appropriate.

For example, multi channel intensity data may be compatible with a first coding standard, such as MP3, AAC etc. The single channel signal may be encoded according to the same encoding standard. The multi channel parameters may be parametric extension data and may specifically be parametric stereo data which may be used to provide a stereo signal from the single channel signal and possibly from the intensity data. The multi channel parameters may be in a format which is not comprised in the encoding standard used for the single channel signal or for the multi channel intensity data.

The multi channel parameters may be included in an ancillary (or auxiliary) data section of the encoded audio output data. For example, the multi channel parameters may be included in the ancillary data sections of an MP3 or AAC data stream.

The single channel signal, parametrically encoded multi channel parameters comprising multi channel information related to the single channel signal and intensity encoded multi channel intensity data related to the single channel signal may be comprised in a single data stream or file.

The multi channel parameters preferably comprise Inter-channel Intensity Difference (IID) parameters; Inter-channel Time Difference (ITD) parameters; and/or Inter-channel Cross-Correlations (ICC) parameters. Preferably, the IID parameters are difference parameters relative to the intensity data. Particularly, the intensity data preferably comprises individual scale factors for multiple channels and preferably the multi channel parameters comprise scale factor difference values relative to the individual scale factors of the intensity data.

Preferably, the multi channel audio decoder is a stereo audio decoder.

According to a feature of the invention, the first decoded signal is a multi channel signal and the intensity decoder is operable to modify the intensity data in response to intensity information of the parametrically encoded multi channel parameters. This provides for a suitable implementation and in particular allows an existing intensity data multi channel decoder algorithm to be used.

According to a fourth aspect of the invention there is provided a multi channel audio decoder comprising: means for receiving a single channel signal, parametrically encoded multi channel parameters comprising multi channel information related to the single channel signal and intensity encoded multi channel intensity data related to the single channel signal; an intensity decoder for generating a first decoded signal from the single channel signal; and a parametric multi channel decoder operable to generate a decoded multi channel output signal from the first decoded signal, the intensity data and the parametrically encoded multi channel parameters.

According to another feature of the invention, the first decoded signal is a mono signal and the parametric multi channel decoder is operable to modify intensity information of the parametrically encoded multi channel parameters in response to the intensity data. This provides for a suitable implementation and in particular allows a simple intensity data multi channel decoder algorithm to be used.

According to a fifth aspect of the invention, there is provided a method of multi channel audio decoding comprising the steps of: receiving a single channel signal, parametrically encoded multi channel parameters comprising multi channel information related to the single channel signal and intensity encoded multi channel intensity data related to the single channel signal; generating a first decoded signal from the single channel signal and the intensity data by intensity decoding; and generating a decoded multi channel output signal from the first decoded signal and the parametrically encoded multi channel parameters by parametric multi channel decoding.

According to a sixth aspect of the invention, there is provided a multi channel audio signal comprising: single channel signal data, intensity encoded multi channel intensity data related to the single channel signal, the multi channel intensity data being encoded in accordance with a first encoding protocol; and parametrically encoded multi channel parameters comprising multi channel information related to the single channel signal, the parametrically encoded multi channel parameters being encoded in accordance with a second encoding protocol different than the first encoding protocol. Preferably, the single channel data is encoded in accordance with the first encoding protocol.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates a block diagram of an encoder in accordance with an embodiment of the invention;

FIG. 2 illustrates a block diagram of a decoder in accordance with an embodiment of the invention;

FIG. 3 illustrates a block diagram of a decoder in accordance with an embodiment of the invention.

### DESCRIPTION OF PREFERRED EMBODIMENTS

The following description focuses on an embodiment of the invention applicable to stereo encoders and decoders and in particular to encoding and decoding of digital audio data comprising audio data compatible with the MPEG Audio Layer II (mp2) encoding standard and further comprising Parametric Stereo (PS) parametric extension data. However, it will be appreciated that the invention is not limited to this application but may be applied to many other forms of multi channel systems.

In accordance with the described embodiment, intensity stereo encoding is used in an encoder to generate information for a quality limited stereo signal. The intensity stereo encoding is performed in accordance with the encoding protocol used for the underlying signal. Specifically, mp2 stereo intensity encoding is used. In parallel, the encoder generates parametrically encoded PS extension data which is included in the ancillary data sections of the mp2 data.

Accordingly, legacy decoders not capable of exploiting the PS extension data may still generate a stereo signal, albeit of a reduced quality and with the typical disadvantages associated with intensity stereo encoding. However, users with upgraded or enhanced decoders may receive high quality stereo without the typical intensity stereo artefacts as these decoders may process the encoded signal in response to the PS extension data. The data rate required for communication of the encoded data in order to achieve a given stereo quality is significantly reduced in comparison to the legacy systems as the extension data provides for a much improved stereo encoding.

Furthermore, the PS extension data size may be reduced by exploiting the correlation between the stereo intensity data and the PS extension data. For example, the correlation between the stereo intensity data and Inter-channel Intensity Difference (IID) parameters of the PS extension data may be exploited in the encoding of the IID parameters. In particular, the IID parameters may be encoded differentially with respect to the stereo intensity data.

In the described embodiment, a stereo encoder receives a stereo signal. The lower frequency band (in general below a certain frequency f_{c}) is encoded as two mono signals. In addition, the stereo encoder generates a substantially mono signal for a higher frequency range (in general above f_{c}). This signal is subsequently encoded as an intensity stereo signal by derivation of stereo intensity data. In addition, PS stereo parameters are generated in response to the mono signal. The encoder subsequently generates output data comprising the dual mono encoded lower frequency signals, the mono signal and both the intensity data and the PS stereo parameters. Preferably, the output data is a data stream compatible with an encoding standard allowing intensity stereo such as mp2. The parametric stereo data may be contained in ancillary data sections of the output data. Thus, legacy decoders may decode the data stream using the intensity stereo data thereby generating a reduced quality stereo signal. Enhanced decoders may use all the available data and may thus generate enhanced quality stereo signals.

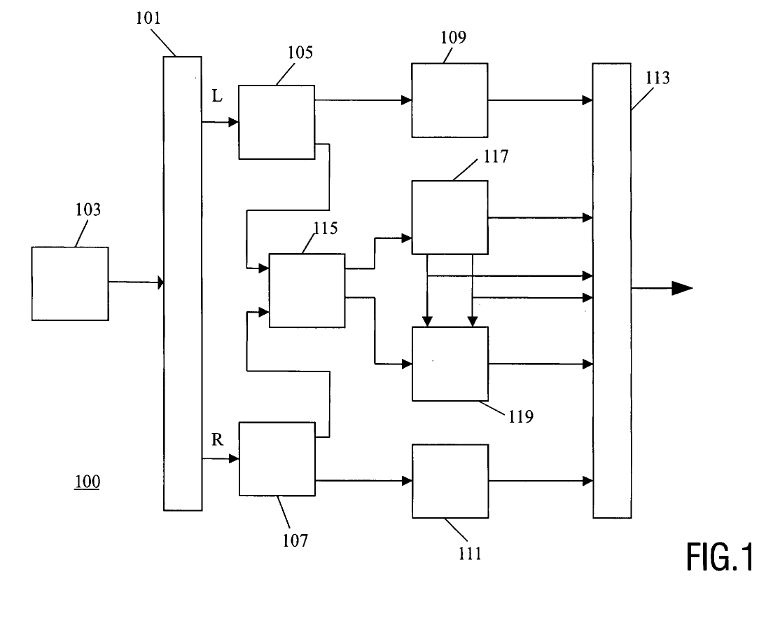

FIG. 1 illustrates a block diagram of an encoder 100 in accordance with an embodiment of the invention.

The encoder 100 comprises a receiver 101 which receives an input stereo signal from an external or internal source 103. In the specific embodiment, the input stereo signal comprises a left channel pulse code modulated signal and a right channel pulse code modulated signal. The receiver 101 is coupled to a first and second divider 105, 107 and the left stereo channel is fed to the first divider 105 and the right stereo channel is fed to the second divider 107.

The first divider 105 divides the left stereo signal into a first and second part. Specifically, the first part corresponds to a higher frequency range and the second part corresponds to a lower frequency range. Similarly, the second divider 107 divides the left stereo signal into a first and second part corresponding to an upper and lower frequency range.

In the described embodiment, the first and second dividers 105, 107 comprise a low pass filter for extracting the lower frequency signal and a high pass filter for extracting the higher frequency signal. Alternatively, the analysis subband filters that are part of a regular mp2 encoder can be used for this purpose, i.e the lower subbands form the second part and the higher subbands form the first part.

The first divider 105 is coupled to a first mono audio encoder 109 and the second divider 107 is coupled to a second mono audio encoder 111. The left lower frequency signal is fed from the first divider 105 to the first mono audio encoder 109 and the right lower frequency signal is fed from the second divider 107 to the second mono audio encoder 111.

The first and second mono audio encoders 109, 111 encode the left and right channel lower frequency signal respectively in accordance with a suitable encoding protocol, such as e.g. an mp2 encoding protocol. The first and second mono audio encoders 109, 111 are coupled to an output processor 113 and the encoded lower frequency range right and left channel data is fed to the output processor 113. Thus, the lower frequency range of the left and right input signal is individually encoded as two mono signals.

The first and second divider 105, 107 are further coupled to a parametric stereo encoder 115. The first divider 105 feeds the left channel higher frequency signal to the parametric stereo encoder 115 and the second divider 107 feeds the right channel higher frequency signal to the parametric stereo encoder 115.

The parametric stereo encoder 115 generates a mono signal from the left and right channel higher frequency signals. Specifically, the mono signal may be generated simply by adding the signals together. In addition, the parametric stereo encoder 115 generates multi channel parameters for the higher frequency ranges of the input stereo signals. Specifically, the parametric stereo encoder 115 may generate Parametric Stereo (PS) multi channel parameters. Accordingly, the parametric stereo encoder 115 in this embodiment generates Inter-channel Intensity Difference (IID), Inter-channel Time Difference (ITD) and Inter-channel Cross-Correlations (ICC) parameters.

The parametric stereo encoder 115 is coupled to a stereo intensity encoder 117 which is fed to the high frequency range mono signal. The stereo intensity encoder 117 is further fed the left and right channel higher frequency signals which were derived by the first and second divider 105, 107. In the example of FIG. 1, the stereo intensity encoder 117 is fed the left and right channel higher frequency signals from the stereo intensity encoder 117 rather than directly from the first and second divider 105, 107.

In the embodiment, the stereo intensity encoder 117 is a subband encoder which performs an intensity encoding of the left and right channel higher frequency signals by determining intensity data which a decoder may apply to the high frequency range mono signal generated by the parametric stereo encoder 115 to generate left and right signals respectively.

In the embodiment, the stereo intensity encoder 117 further performs an encoding of the mono signal in accordance with the appropriate encoding protocol (such as mp2). The stereo intensity encoder 117 specifically determines the stereo intensity data as individual left and right scale factors which should be applied by a decoder to the subbands of the subband encoded mono signal to derive left and right channel signals.

The stereo intensity encoder 117 is coupled to the output processor 113 which is fed the subband encoded mono signal data as well as the determined intensity data (i.e. the scale factors). Thus, the output processor 113 is supplied with an intensity encoded higher frequency range stereo signal which complements the two mono encoded lower frequency range signals from the first and second mono audio encoders 109, 111. The output processor 113 therefore receives data allowing it to generate an mp2 compatible intensity encoded stereo signal.

The parametric stereo encoder 115 and stereo intensity encoder 117 are further coupled to a PS stereo parameter processor 119. The stereo parameter processor 119 is fed the IID, ITD and ICC PS stereo parameters from the parametric stereo encoder 115 and optionally the intensity data from the stereo intensity encoder 117.

The stereo parameter processor 119 is coupled to the output processor 113 and processes the PS stereo parameters and feeds them to the output processor 113. In a simple embodiment, the stereo parameter processor 119 simply forwards the PS stereo parameters to the output processor 119. However, in the described embodiment, the stereo parameter processor 119 forwards the ITD and ICC parameters but processes the IID parameters to generate difference parameters relative to the intensity data.

Specifically, the IID parameters are determined as the scale factor difference between the scale factors determined by the stereo intensity encoder 117 and those determined by the parametric stereo encoder 115. As the scale factors generated by the stereo intensity encoder 117 typically are very close to those generated by the parametric stereo encoder 115, only relatively small difference values must be included thereby permitting an efficient encoding of the delta IID values.

In the embodiment of FIG. 1, the output processor 113 generates a single mp2 compliant bit stream by combining the two mono encoded lower frequency range signals, the encoded higher frequency range mono signal and the intensity data from the stereo intensity encoder 117 in accordance with the mp2 requirements. In addition, the PS stereo parameters are included in the ancillary data sections of the mp2 data stream. Thus, a single data stream is generated which may be encoded as an intensity stereo signal in all legacy mp2 encoders yet may provide a high quality stereo signal in PS capable decoders. Furthermore, the differential encoding of the IID parameters results in the data rate being only marginally higher than a conventionally PS encoded signal for which only mono signals can be generated by legacy decoders.

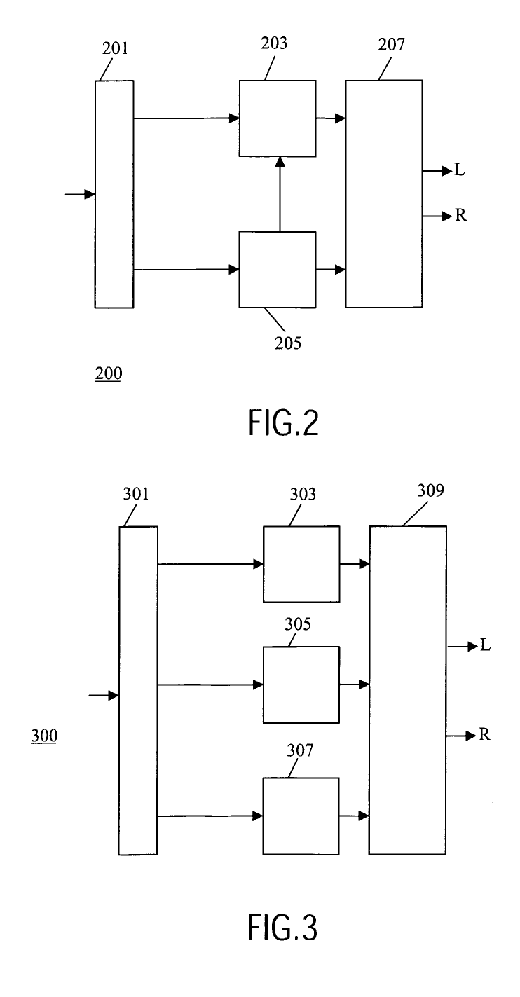

FIG. 2 illustrates a block diagram of a stereo decoder 200 in accordance with an embodiment of the invention. The decoder 200 of FIG. 2 is capable of generating a high quality stereo signal from the signal generated by the encoder of FIG. 1 and will be described with reference to this.

The decoder 200 comprises a receiver 201 which receives the mp2 data stream comprising PS extension data generated by the encoder 100 of FIG. 1. Thus, the receiver receives a data stream comprising two mono encoded lower frequency range signals, a mono higher frequency range signal, intensity encoded stereo data (the mp2 scale factors generated by the stereo intensity encoder 117) and the parametrically encoded stereo parameters (the ICC, ITD and difference IID parameters).

The receiver is coupled to an mp2 decoding processor 203 which is operable to generate a stereo signal in accordance with an mp2 intensity stereo decoding algorithm. The receiver 201 feeds the mp2 compatible data of the input data stream to the mp2 decoding processor 203 (i.e. the two mono encoded lower frequency range signals, a mono higher frequency range signal and the intensity encoded stereo data).

In addition, the decoder 200 comprises a parameter decoder 205 which is coupled to the receiver 201 and which receives the parametrically encoded stereo parameters. The parameter decoder 205 is coupled to the mp2 decoding processor 203 and in the embodiment of FIG. 2, the parameter decoder 205 feeds the difference IID parameters to the mp2 decoding processor 203.

The difference IID parameters are used by the intensity decoder 203 to adjust the mp2 scale factors such that more accurate scale factors are used. The intensity decoder 203 accordingly generates a stereo signal in accordance with an mp2 stereo algorithm but using improved scale factor values.

The decoder 200 furthermore comprises a parametric stereo decoder 207 which is coupled to the parameter decoder 205 and the intensity decoder 203. The parametric stereo decoder 207 receives the decoded stereo signal from the intensity decoder 203 and the ITD and ICC parameters from the parameter processor 205 and applies these to the decoded stereo signal in accordance with the parametric stereo decoding protocol. Thus, the parametric stereo decoder 207 generates a high quality stereo signal by performing a parametric stereo decoding using the PS extension data of the received data stream.

In the embodiment of FIG. 2, the IID parameter decoding of the PS encoded stereo signal was performed in the intensity decoder 203 and the IIC and ITD parameter decoding was performed in the parametric stereo decoder 207. It will be appreciated that other distributions of functionality may be applied and that the functionality of the intensity decoder 203 and parametric stereo decoder 207 may be partitioned in any suitable way. Specifically, it will be appreciated that functionality of the intensity decoder 203 and the parametric stereo decoder 207 may be combined in one processing block. This may allow (at least part of) the processing to be performed on subband signals.

FIG. 3 illustrates a block diagram of a decoder 300 in accordance with a different embodiment of the invention.

Similarly to the decoder 200 of FIG. 2, the decoder 300 of FIG. 3 comprises a receiver 301 which receives the mp2 data stream comprising PS extension data generated by the encoder 100 of FIG. 1. However, the decoder 300 of FIG. 3 comprises an intensity decoder 303 which only generates a mono signal. Hence, in this embodiment, the receiver 301 feeds only the high frequency mono range signal to the intensity decoder 303. The intensity decoder 303 in response generates a high frequency range pulse code modulated (PCM) mono signal in accordance with an mp2 algorithm.

In addition, the decoder 300 of FIG. 3 comprises a double mono decoder 305 which is coupled to the receiver 301. The double mono decoder 305 receives the two mono encoded lower frequency range signals and decodes these in accordance with the mp2 protocol. It will be appreciated that a single subband decoder may be used for both the intensity decoder 303 and the double mono decoder 305 and that the high frequency range mono signal and the two mono encoded lower frequency range signals may be sequentially decoded by this.

In addition, the decoder 300 comprises a parameter processor 307 which is coupled to the receiver and which receives the intensity encoded stereo data (the mp2 scale factors generated by the stereo intensity encoder 117) and the parametrically encoded stereo parameters (the ICC, ITD and difference IID parameters).

The parameter processor 307 generates absolute IID parameters in response to the mp2 scale factors and the difference IID parameters. In addition, the parameter processor 307 may generate mono scale factors for the intensity decoder 303. The mono scale factors may be generated by the encoder and transmitted as ancillary data. These mono scale factors are then fed to the subband decoder to generate a mono signal without aliasing distortion.

The decoder 300 further comprises a parametric stereo decoder 309 which is coupled to the intensity decoder 303, the double mono decoder 305 and the parameter processor 307. Accordingly, the parametric stereo decoder 309 receives the decoded high frequency range mono signal, the two lower frequency range signals and the ICC, ITD and absolute IID parameters. The parametric stereo decoder 309 then proceeds to generate a high quality stereo signal by performing a parametric stereo decoding using the PS extension data of the received data stream.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A multi channel audio encoder comprising:
means (101) for receiving an input multi channel signal;
a parametric multi channel encoder (115) for generating a single channel signal and multi channel parameters for at least a first part of the input multi channel signal; the multi channel parameters comprising multi channel information related to the single channel signal;
a multi channel intensity encoder (117) for generating multi channel intensity data in response to the input multi channel signal and the single channel signal; and
means (113) for generating encoded audio output data comprising the single channel signal, the intensity data and the multi channel parameters.

2. A multi channel audio encoder as claimed in claim 1 wherein the multi channel parameters comprise Inter-channel Intensity Difference (IID) parameters.

3. A multi channel audio encoder as claimed in claim 2 wherein the Inter-channel Intensity Difference (IID) parameters are difference parameters relative to the intensity data.

4. A multi channel audio encoder as claimed in claim 1 wherein the multi channel parameters comprise Inter-channel Time Difference (ITD) parameters.

5. A multi channel audio encoder as claimed in claim 1 wherein the multi channel parameters comprise Inter-channel Cross-Correlations (ICC) parameters.

6. A multi channel audio encoder as claimed in claim 1 wherein the intensity data comprises individual scale factors for multiple channels.

7. A multi channel audio encoder as claimed in claim 6 wherein the multi channel parameters comprise scale factor difference values relative to the individual scale factors of the intensity data.

8. A multi channel audio encoder as claimed in claim 1 further comprising
means (105, 107) for dividing the input multi channel signal into the first part and a second part; and
means (109, 111) for encoding the second part as a plurality of individually encoded single channel signals;
and wherein the means (113) for generating is operable to include the individually encoded single channel signals in the encoded audio output data.

9. A multi channel audio encoder as claimed in claim 8 wherein the second part corresponds to a low frequency band of the input signal and the first part corresponds to a high frequency band of the input signal.

10. A multi channel audio encoder as claimed in claim 1 wherein the multi channel audio encoder is a stereo audio encoder.

11. A multi channel audio encoder as claimed in claim 1 further comprising means for transmitting the encoded audio output data as a single data stream.

12. A method of encoding an audio signal comprising the steps of:
receiving an input multi channel signal;
generating a single channel signal and multi channel parameters for at least a first part of the input multi channel signal by parametric multi channel encoding; the multi channel parameters comprising multi channel information related to the single channel signal;
generating multi channel intensity data in response to the input multi channel signal and the single channel signal; and
generating encoded audio output data comprising the single channel signal, the intensity data and the multi channel parameters.

13. A multi channel audio decoder comprising:
means for receiving (201) a single channel signal, parametrically encoded multi channel parameters comprising multi channel information related to the single channel signal and intensity encoded multi channel intensity data related to the single channel signal;
an intensity decoder (203) for generating a first decoded signal from the single channel signal and the intensity data; and
a parametric multi channel decoder (207) operable to generate a decoded multi channel output signal from the first decoded signal and the parametrically encoded multi channel parameters.

14. A multi channel audio decoder as claimed in claim 13 wherein the first decoded signal is a multi channel signal and the intensity decoder (203) is operable to modify the intensity data in response to intensity information of the parametrically encoded multi channel parameters.

15. A multi channel audio decoder comprising:
means for receiving (301) a single channel signal, parametrically encoded multi channel parameters comprising multi channel information related to the single channel signal and intensity encoded multi channel intensity data related to the single channel signal;
an intensity decoder (303) for generating a first decoded signal from the single channel signal; and
a parametric multi channel decoder (309) operable to generate a decoded multi channel output signal from the first decoded signal, the intensity data and the parametrically encoded multi channel parameters.

16. A multi channel audio decoder as claimed in claim 15 wherein the first decoded signal is a mono signal and the parametric multi channel decoder (309) is operable to modify intensity information of the parametrically encoded multi channel parameters in response to the intensity data.

17. A method of multi channel audio decoding comprising the steps of:
receiving a single channel signal, parametrically encoded multi channel parameters comprising multi channel information related to the single channel signal and intensity encoded multi channel intensity data related to the single channel signal;
generating a first decoded signal from the single channel signal and the intensity data by intensity decoding; and
generating a decoded multi channel output signal from the first decoded signal and the parametrically encoded multi channel parameters by parametric multi channel decoding.

18. A computer program enabling the carrying out of a method according to claim 12 or of a method according to claim 17.

19. A record carrier comprising a computer program as claimed in claim 18.

20. A multi channel audio distribution system comprising a multi channel audio encoder in accordance with claim 1 and a multi channel audio decoder in accordance with claim 13 or claim 15.

21. A multi channel audio signal comprising: single channel signal data,
intensity encoded multi channel intensity data related to the single channel signal, the multi channel intensity data being encoded in accordance with a first encoding protocol; and
parametrically encoded multi channel parameters comprising multi channel information related to the single channel signal, the parametrically encoded multi channel parameters being encoded in accordance with a second encoding protocol different than the first encoding protocol.

22. A multi channel audio signal as claimed in claim 21 wherein the single channel data is encoded in accordance with the first encoding protocol.
